(19) United States
(12) Patent Application Publication
(10) Pub. No.: US 2003/0149620 A1
(43) Pub. Date: Aug. 7, 2003

(54) System for offering services using network of unowned computers

(76) Inventor: Blaine D. Gaither, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/071,442

(22) Filed: Feb. 6, 2002

(51) Int. Cl. G06F 15/173; G06F 17/60

(52) U.S. Cl. 705/14; 709/226

(57) ABSTRACT

A system whereby vendors of computer systems may advantageously utilize the processing capability of the computers in these systems after the systems have been sold. The system provides computer services via a network of computers which have been sold with an agreement from the buyers thereof to permit the seller to conditionally utilize the computers subsequent to the sale thereof.

### FIELD OF THE INVENTION

The present invention relates generally to computer services, and more particularly, to a system for providing a service via a network of computers which have been sold with an agreement from the buyers thereof to permit the seller to conditionally utilize the computers subsequent to the sale thereof.

### BACKGROUND OF THE INVENTION

1. Statement of the Problem

Vendors of computer systems earn most of their revenue from sales of computers, and earn supplementary revenue from non-hardware sales such as service contracts. Computer systems vendors do not generally engage in the business of providing computer services, as this requires the use of a large number of dedicated computer devices, such as servers. Conversely, application service providers (ASPs) and Internet service providers (ISPs) such as AOL, for example, do not generally engage in the business of selling computer systems.

Heretofore, there has been no known way to inexpensively provide the equipment necessary for computer systems vendors to break into the service provider market. What is needed is a method whereby computer systems vendors may competitively function as a service provider without making a large investment in dedicated computer hardware.

2. Solution to the Problem

The present system provides a mechanism by which vendors of computer systems may advantageously utilize the processing capability of the computers in these systems after the systems have been sold. More specifically, the present system provides computer services via a peer-to-peer or other network of computers which have been sold with an agreement from the buyers thereof to permit the seller to conditionally utilize the computers subsequent to the sale thereof.

Using the present system, a company that makes and/or sells a large number of computer systems such as personal computers (PCs) has an opportunity to profit from the end-users' usage patterns of the computers in those systems. A typical home computer is often completely unused during business hours, while the user is at work. Furthermore, even when home or business PCs are in use, the processors and I/O subsystems are idle most of the time, since the average user does not tap but a small percentage of a computer's processing power in normal use.

In the present system, a vendor that has sold a computer to a purchaser enters into an agreement with the purchaser whereby the vendor retains the right to use idle processor cycles, or alternatively, a minimum amount of processor time in a particular period of time. The vendor may use low priority CPU (processor) cycles to run an application for the vendor's commercial benefit. In return for this conditional use of the purchaser's PC, the purchaser receives a financial benefit in the form of a discounted purchase price, improved financing terms, discounted or free service, or other benefit.

The present system utilizes a network of purchasers' computers as servers for applications such as, for example, a distributed content provider service, or web page hosting, where each file or web page may be redundantly served from several purchasers' systems to ensure that a given page is available even if one or more systems are down or unavailable. The computer vendor generates revenue by charging either the web page (or service) requester, or the web page owner, for the service.

Therefore, a very large server may be constructed of computer systems that are not owned or in the possession of the seller of the systems. A commercial service may thus be offered via the use of a very large network of computers that are not owned by the provider of the service.

### BRIEF DESCRIPTION OF THE DRAWINGS

FIG. 1 is a flowchart illustrating basic steps employed by the present system in an exemplary embodiment;

FIG. 2 is a diagram of an exemplary network employed by the present system;

FIG. 3 is a flowchart illustrating an exemplary embodiment of the present system functioning as a distributed content provider service in a distributed environment;

FIG. 4 is a flowchart illustrating an exemplary embodiment of the present system functioning as a web page hosting service in a peer-to-peer environment; and

FIG. 5 is a diagram of an alternative embodiment of the present system showing operational details in the context of an exemplary peer-to-peer network.

### DETAILED DESCRIPTION

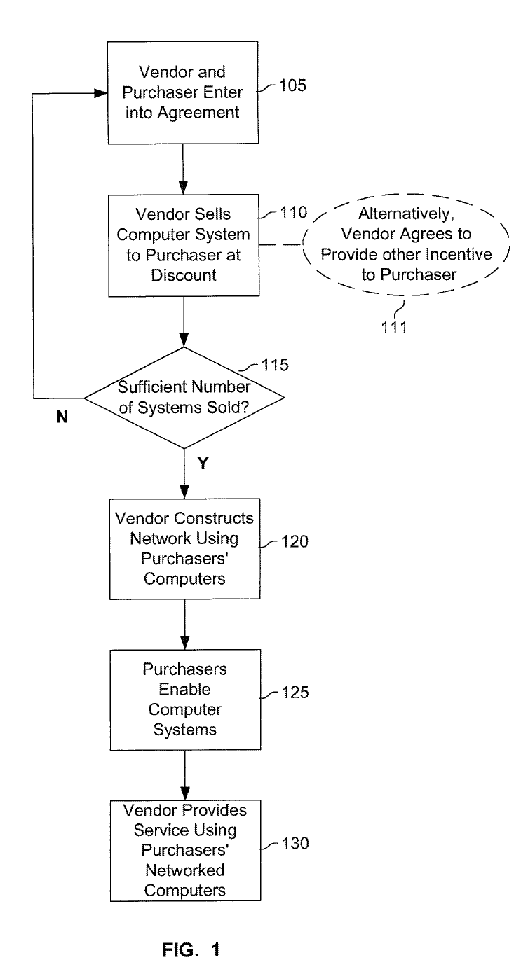

FIG. 1 illustrates basic steps employed by the present system in an exemplary embodiment. As used herein, the term ‘vendor’ denotes the entity that conveys ownership in, or the right to use (hereinafter ‘sells’), equipment comprising computer hardware (hereinafter the ‘computer system’) that includes a digital processor; the term ‘purchaser’ denotes the person or other (e.g., corporate) entity that obtains the equipment from the vendor by purchase, or any other mechanism, such as a lease/purchase agreement, subject to a provision concerning subsequent use of the hardware by the vendor, as described below. The user of the equipment may be either the purchaser or a third party, such as an entity having an appropriate agreement with the purchaser concerning use of the equipment. It is to be noted that one or more of the computers 200(*) may be used by an entity that is neither a purchaser nor a party that is contractually obligated to or otherwise in privity with either a purchaser or the vendor.

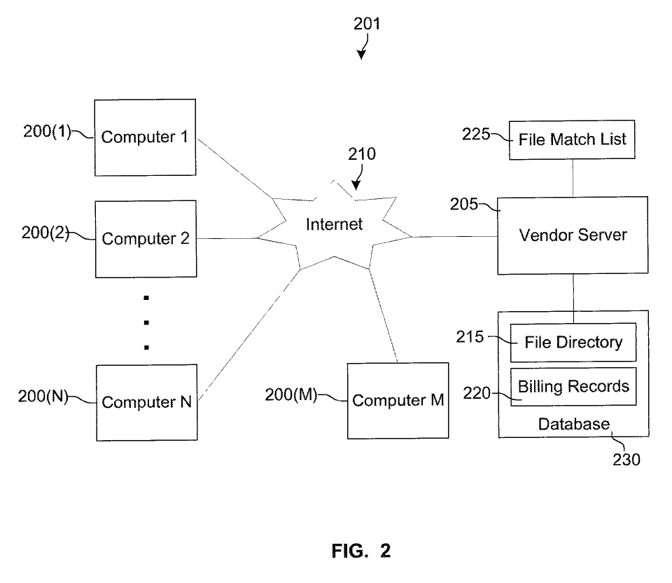

FIG. 2 is a diagram showing an exemplary network 201 employed in the present system. The network 201 shown in FIG. 2 may be either a peer-to-peer network, or a more traditional distributed network. When either type of network is used, a plurality of user computers 200(*) [where the “*” symbol is used to denote any one of a group of similar entities] are interconnected via the Internet 210. Note that, in addition to a networking program that is used to implement one of the types of networks 201/500 described herein, the purchaser's (or other user's) Internet connection or link is employed as an intercommunication mechanism between computers 200(*) on a given network. Each user computer 200(*) is a computer which may be a customer's computer or a computer used by a non-customer user of the network 201/500. Computers 200(*) include personal computers (PCs) and any other type of devices having an embedded processor, such as printers, game stations, television set-top boxes, appliances, and/or telephones.

Although generally, at least one vendor server 205 is present in a distributed network, in an embodiment using a peer-to-peer network, a vendor server is not required, and is therefore not necessarily present.

Each computer 200(*) may be partitioned to include an area for the user's data, and one or more safe areas for the vendor's data. Partitioning facilities such as Hypervisor (sold by VMware Corp.), virtual environments such as deployed in Hewlett-Packard's HP-UX, or hard partitioning, as is well-known in the art, may be employed to provide data security for the vendor's data. The vendor's software (applications and/or networking programs) may run as an application at a relatively low priority in top of the user's operating system, in a manner similar to a spooler, the operation of which is well-known in the art.

Operation of the present system is best understood by viewing FIGS. 1 and 2 in conjunction with one another. As shown in FIG. 1, at step 105, the vendor and purchaser enter into an agreement whereby the vendor of a computer system may utilize the processing capability of the system's computer 200(*) after the system has been conveyed to the purchaser. The vendor may retain the right to use idle processor (CPU) cycles, or alternatively, a specified amount of processor time (which may include non-idle processor cycles) over the course of a particular period of time. In addition, the agreement may also specify that a subset of space on the computer's disk drive also be made available for the vendor's use. The vendor may use this disk space and low priority (or other) processor cycles to run an application for the vendor's commercial benefit. In return for this conditional use of the purchaser's computer, the purchaser receives some purchasing incentive or benefit, as indicated below.

At step 110, the vendor sells the computer system, including computer 200(*), to the purchaser at a discount, or, alternatively (step 111) provides the purchaser some other purchasing incentive, such as a discounted interest rate (if financed), free/discounted maintenance or support, free/discounted peripheral equipment or other add-ons, cash back, or some other benefit. Steps 105 and 110 may be concurrently executed.

The vendor continues to sell computer systems per steps 105/110 until, at step 115, a predetermined minimum number of systems, sufficient to function as a practicable network, have been sold. A network may be created, technically speaking, using as few as 3 computers. However, from a practical standpoint, a minimum of between several hundred and a thousand computers is required to provide a network that would provide a sufficient amount of processing power and data storage, as well as sufficient vendor profitability, to implement the present method.

At step 120, the vendor constructs a network 201 that utilizes the purchasers' computers. This network 201 may be a distributed network with a central server, or a peer-to-peer network, as described below. Note that network 201 may comprise a purchaser's existing Internet connection.

At step 125, the purchasers, which are now system ‘users’, enable their computer systems so that each of the computers 200(*) may be used as a network peer and/or node. This step may be as simple as plugging in the computer system and connecting it to a local Internet service provider.

At step 130, the vendor provides one or more services using the users' networked computers 200(*). These services may include any of the following, or other services that provide some benefit to the vendor, a third party (i.e., an entity other than the vendor), or both:

(a) Internet web page hosting

(b) Internet service provider (ISP) data processing

(c) processing for cable television operators or other service providers

(d) distributed content provider services

(e) application service provider (ASP) services

Services that directly benefit a third party, such as an Internet service provider (ISP) or a cable television company, are set up so that the vendor receives revenue derived from the third party's use of the vendor's network 201 of purchasers' computer systems 200(*). Regardless of the type of service provided by the network 201, the vendor receives remuneration based on use of the network.

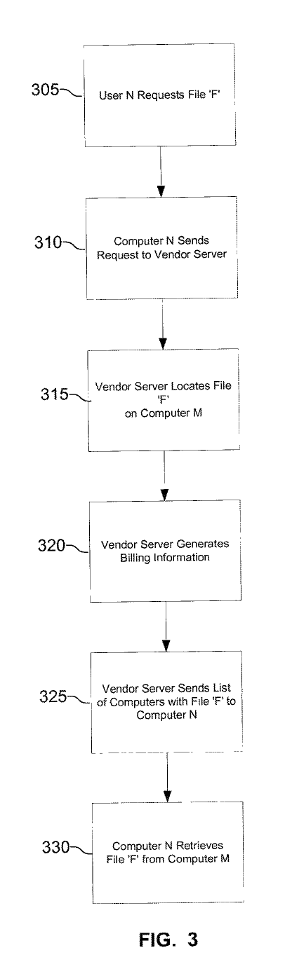

FIG. 3 is a flowchart illustrating an exemplary embodiment of the present system using a distributed content provider service in ‘peer-like’ distributed network 201. The presently described network may be implemented in the manner of a peer-like network well-known in the art, such as the network used by Napster. Operation of the present system is best understood by viewing FIGS. 2 and 3 in conjunction with one another. In the distributed content provider service shown in FIG. 3, at step 305, user N [operating computer 200(N)] requests specified data, for example, File ‘F’, by sending a search request (i.e., a query) for the file to the central (vendor) server 205 via the Internet 210, at step 310.

Vendor server 205 maintains a list of all of the purchaser or other user computers connected to it along with their IP addresses and the various files stored on, or otherwise directly accessible by, their respective computers. This list is placed in a directory 215 database 230. At step 315, when a user requests a certain file, the vendor server queries file directory 215 to determine which of the on-line computers in network 200 have the requested file. Vendor server 205 then generates a list of files 225 that match the user's search request. Assume, for the purpose of the present example, that computer M has the particular file requested. In an exemplary embodiment, file match list 225 contains information for file F, such as the corresponding IP address, file size, bit rate, and other relevant information. Similar information for each additional file matching the request is also included in list 225. In an exemplary embodiment, each potentially available file is redundantly served from several purchasers' computers 200(*) to ensure that a given file is available even if one or more systems are down or unavailable.

At step 320, assuming a ‘hit’ (i.e., a file matching the requested file) was found, vendor server 205 generates the appropriate billing information for user N, and stores it in a billing record file 220 in database 230. Alternatively, billing information may be generated in step 330 by a user computer 200(*) and stored in the computer in a secure area for subsequent access by vendor computer 205.

At step 325, vendor server 205 returns file match list 225 to computer N. At step 330, user N retrieves the desired file (file F) from computer M. User N first selects a file from list 225 to download. Computer 200(N) then attempts to establish a direct connection to a computer, e.g., computer 200(M), that has stored a copy of the requested file. In this situation, computer 200(M) functions as a ‘server’ and computer 200(N) functions as the corresponding ‘client’. In an exemplary embodiment, prior to connecting to a server computer, if there is more than one computer in the file match list 225, the client ‘pings’ each computer in the list, computes the round trip time to each computer and then displays the results. Computer 200(N) then requests the transfer of file F directly from the closest server or another server selected by the user.

Next, client computer 200(N) sends a message to server computer 200(M) containing the name of the file requested (e.g., file “F”) and IP address for client computer 200(N). If a connection is successfully made, the server then transfers the file to the client. Once the file is downloaded, the server computer breaks the connection with the client.

The system described above with respect to FIGS. 2 and 3 can also (or alternatively) be employed to locate and transfer data such as web page data and the like.

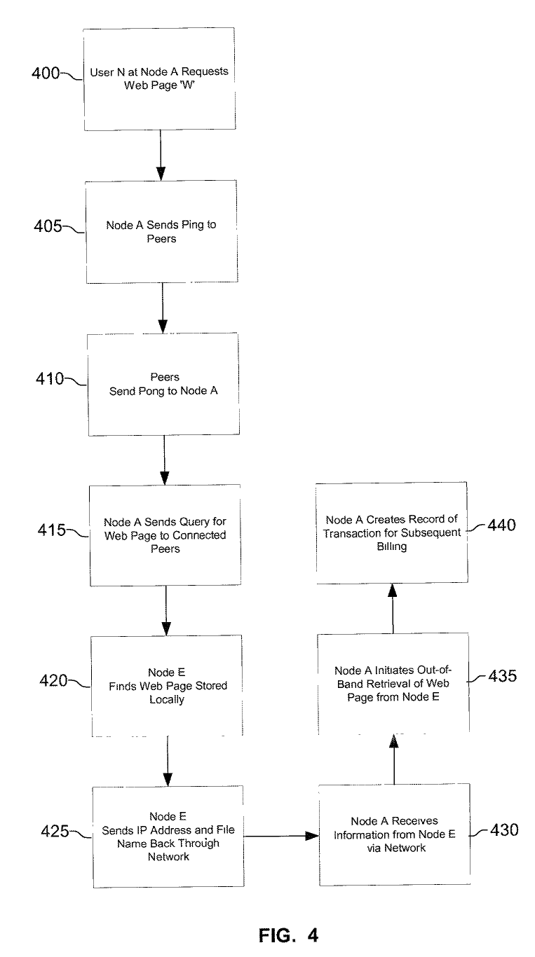

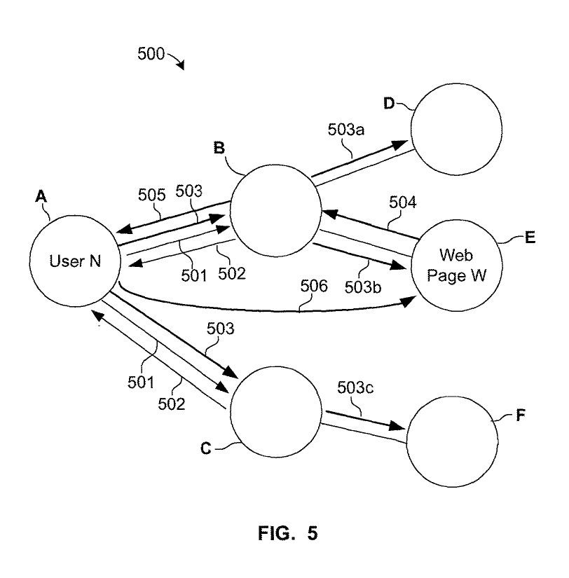

FIG. 4 is a flowchart illustrating an exemplary embodiment of the present system functioning as a web page hosting service in a peer-to-peer environment, and FIG. 5 is a diagram of an exemplary embodiment of the present system showing operational details in the context of a peer-to-peer network. Operation of the present system is best understood by viewing FIGS. 4 and 5 in conjunction with one another.

A peer-to-peer network is a type of transient Internet network that allows a group of computer users with the same networking program to connect with each other and directly access files from one another's disk drives. Every peer (i.e., each node) in the network of the present embodiment is a ‘servent’, an entity that acts as both a client and a server. The architecture of the present embodiment includes a dynamically changing set of nodes connected using TCP/IP protocol. Every node (servent) acts as a client who originates queries, and a server that provides file information and acts as a router. The presently described network may be implemented in the manner of a peer-to-peer network well-known in the art, such as Gnutellanet. The principal architectural difference between the presently described network 500 and the network 201 of FIG. 2 is the presence of a centralized server 205 in network 201 and the absence thereof in network 500.

The present network consists of a set of nodes that are interconnected at a given point in time. Nodes A-F are shown in the exemplary network 500 of FIG. 5. Steps 400-410 involve identifying other peers on the network. At step 400 (in FIG. 4), user N, at node A, requests web page ‘W’. If user N is a new user, an instance of a node (node A in the present case) is initiated by launching a networking program. This program may either be downloaded, loaded via a disk, or pre-installed in the computer. In an exemplary embodiment, the networking program is part of a reference platform that is shipped to each purchaser that represents a node of the network 500 (as well as network 201) of the present system. Alternatively, the entity requesting a web page may be external to the network 500, in which case the site (network node) receiving the request issues a corresponding search request to other peers on the network 500.

For each connection between peers, a node has to know the IP address of the other node that is already on-line. Initially, at step 405, node A connects to the network and ‘pings’ the adjacent nodes (B and C) to discover new nodes on the network, as shown by arrows 501 between node A and nodes B and C in FIG. 5. A ‘ping’ ‘message requests the transitive closure of connected nodes to identify them, essentially asking the question “are you there?”

In the node interconnection process, at step 410, a ‘pong’ message is sent between nodes as a reply to a ping, as shown by arrows 502 between nodes B/C and node A. A pong indicates “yes, I am here”, and provides information about the node, such as the IP address and port number. Note that pings 501 and pongs 502 are shown only between nodes A, B, and C in FIG. 5, although these signals are exchanged between all adjacent operational nodes in the network. Each node thus locates another node and establishes a connection to it. This extends the net and makes the new nodes' files available to all other nodes on the network. Once connections are established, all nodes use a common peer-to-peer (e.g., Gnutella-type) protocol to communicate with each other.

A query is then sent by node A, at step 415, to search for files shared by other presently connected nodes (i.e., peers) on the network. Each request (query) for a file has a unique number, generated, for example, from random numbers or semi-randomly from something unique to the originating node, such as an Ethernet MAC address. The query contains a query string and, optionally, a minimum requested link speed. The query string is interpreted as a literal sub-string or as a regular expression that is to be matched against local file name paths. In the present example, as indicated by arrows 503, node A sends a request comprising the query to nodes B and C for data matching a particular file, or in the present case, for data matching some text string on a particular web page. If a node does not have data matching the query, it passes the request on to its peers. In the example shown in FIG. 5, nodes B and C do not have the requested web page “W”, and therefore pass the request on to nodes D, E, and F, as indicated by arrows 503a, 503b, and 503c, respectively. Node B (as well as node C) keeps a record that node A has made the request, unlike the handling of a mail or news transmission, where the received information is simply forwarded. In an exemplary embodiment, each web page is redundantly served from several purchasers' systems to ensure that a given page is available even if one or more systems are down or unavailable.

When a node determines that it has locally stored data matching a received request, the node responds by sending relevant information called ‘hits packets’, which typically include a list of one or more file names which match a given query, the size of each file, and the link speed and IP address (or URL) of the responding node. In the present example, at step 420, node E determines that it has a locally stored file matching the request, in this case, web page “W”. Therefore, as indicated by arrow 504, at step 425, response node E sends the relevant hits packets to node B, which remembers that it is meant for node A and passes it through to that node (as indicated by arrow 505).

At step 430, node A receives the hits packets sent from node E via node B. At step 435, node A connects directly to the response node, as indicated by arrow 506, and uses a simplified version of the HTTP protocol to retrieve the requested web page using the returned URL or IP address. Thus, in effect, an out-of band transmission is used to bypass the transient network 500 altogether. The connection between node A (the searching node) and node E (the response node) is made in the same way as a browser would connect to a web server, the response node in effect acting as an HTTP web server.

Message passing in the present embodiment represents a form of spreading activation. As indicated above, whenever a node receives a message, it sends copies out to all of its other connections. This can generate large amounts of redundant traffic. There are two mechanisms by which this traffic may be reduced:

(a) Each message has a time-to-live (TTL) counter that is decremented on every transmission, thus effectively determining the time that the request lives on the network.

(b) Nodes are expected to cache information about messages they receive and if they receive a duplicate, then they do not forward it.

Each node may allow requests to time out, simply by placing them on a queue of a predetermined size and letting old requests drop off the bottom as new ones are added.

Finally, at step 440, node A creates a record of the web page request transaction for the purpose of subsequent billing by the vendor. Alternatively, the owner of the web site supplying the requested web page (node E in the above example) may be billed by the vendor on a per-hit basis.

The system described above with respect to FIGS. 4 and 5 can be employed to locate and transfer non-web page data including text, audio, and video files. Either of the above-described networking methods 201/500 may be employed to provide other services for generating vendor revenue, including processing for cable television operators or other service providers, such as Internet service provider (ISP) or application service provider (ASP) services.

While exemplary embodiments of the present invention have been shown in the drawings and described above, it will be apparent to one skilled in the art that various embodiments of the present invention are possible. For example, the specific sequence of steps described above in FIGS. 1, 3, and 4, as well as the particular network configurations shown in FIGS. 2 and 5, should not be construed as limited to the specific embodiments described herein. Modification may be made to these and other specific elements of the invention without departing from its spirit and scope as expressed in the following claims.

We claim:

1. A system for utilizing a collective processing capability of a plurality of computers after the computers have been sold to purchasers by a vendor, the system comprising the steps of:
entering into a plurality of agreements, each of which is between the vendor and a different one of the purchasers, wherein, with respect to a specific one of the computers to be sold to said one of the purchasers, the vendor retains a right to use said specific one after the sale thereof;
conveying, subject to said agreements, the plurality of the computers to said purchasers;
interconnecting the computers via the Internet to create a network; and
using the network to provide a service that provides the vendor with a commercial benefit.

2. The system of claim 1, wherein each one of said plurality of agreements is entered into prior to the sale of a respective said specific one of the computers via the network.

3. The system of claim 1, wherein the agreement provides a purchasing incentive to each of the purchasers.

4. The system of claim 1, wherein, in response to a query generated by a first one of the computers and received by a second one of the computers, data is sent from the second one of the computers to the first one of the computers.

5. The system of claim 4, wherein said data comprises an Internet web page.

6. The system of claim 1, wherein the network comprises a plurality of nodes, each of which includes one of the computers, and wherein one of the nodes is a vendor node; and
wherein the vendor node maintains a list of all of the computers connected thereto, along with the respective IP addresses for each of the computers, and information identifying files stored on each respective one of the computers.

7. The system of claim 1, wherein the network comprises a plurality of peers, each of which includes one of the computers; and
wherein each of the peers in the network is a servent that acts as both a client and a server to distribute data between the peers in response to a query generated by one of the peers.

8. The system of claim 7, wherein:
said query is distributed between successive said peers until the query is received by one of the peers having access to said data; and
said data is distributed between successive said peers until the data is received by said one of the peers that generated the query.

9. The system of claim 1, wherein said network includes said computers used by entities not in privity with the vendor.

10. The system of claim 1, wherein the right to use said specific one of the computers includes the right to use low-priority processor cycles of the specific one of the computers to effect said service.

11. The system of claim 1, wherein the right to use said specific one of the computers includes the right to use a predetermined amount of processor time of the specific one of the computers to effect said service, within a fixed interval of time.

12. The system of claim 1, wherein the network is used to provide said service after a predetermined minimum number of the computers have been conveyed to the purchasers.

13. The system of claim 1, wherein said computers include devices having an embedded processor.

14. A system for utilizing a collective processing capability of a plurality of devices containing embedded processors, after the devices have been sold to purchasers by a vendor, the system comprising the steps of:
entering into an agreement between the vendor and one of the purchasers wherein, with respect to a specific one of the devices to be sold to said one of the purchasers, the vendor retains a right to use said specific one after the sale thereof;
conveying at least one of the devices to a purchaser, after entering into said agreement; and
repeating the previous two steps until a predetermined minimum number of said devices have been sold.

15. The system of claim 14, including the additional steps of:
interconnecting the devices via the Internet to create a network; and
using the network to provide a service, used by the purchasers, that provides the vendor with a commercial benefit.

16. The system of claim 15, wherein, in response to a query generated by a first one of the devices and received by a second one of the devices, data is sent from the second one of the devices to the first one of the devices via the network.

17. The system of claim 15, wherein the network comprises a plurality of nodes, each of which includes one of the devices, and wherein one of the nodes is a vendor node; and
wherein the vendor node maintains a list of all of the devices connected thereto, along with the respective IP addresses for each of the devices, and information identifying files accessible by each respective one of the devices.

18. The system of claim 15, wherein the network comprises a plurality of peers, each of which includes one of the devices; and
wherein each of the peers in the network is a servent that acts as both a client and a server to distribute data between the peers in response to a query generated by one of the peers.

19. The system of claim 14, wherein the right to use said specific one of the devices includes the right to use low-priority processor cycles of the specific one of the devices to effect said service.

20. The system of claim 14, wherein the right to use said specific one of the devices includes the right to use a predetermined amount of processor time of the specific one of the devices to effect said service, within a fixed interval of time.

21. A system for utilizing a collective processing capability of a plurality of computers comprising the steps of:
(a) entering into an agreement between a vendor of said computers and a purchaser of one of the computers, wherein the vendor retains a right to use the computer after the sale thereof;
(b) conveying said one of the computers to said purchaser, after entering into said agreement;
wherein steps (a) and (b) are repeated with a different said purchaser until a predetermined minimum number of the computers have been sold; and
(c) interconnecting the devices via the Internet to create a network.

22. The system of claim 21, including the additional step of using the network to provide a service.

23. The system of claim 22, wherein, in response to a query generated by a first one of the computers and received by a second one of the computers, data is sent from the second one of the computers to the first one of the computers via the network.

24. The system of claim 22, wherein the network comprises a plurality of nodes, each of which includes one of the computers, and wherein one of the nodes is a vendor node; and
wherein the vendor node maintains a list of all of the computers connected thereto, along with the respective IP addresses for each of the computers, and information identifying files stored on each respective one of the computers.

25. The system of claim 22, wherein the network comprises a plurality of peers, each of which includes one of the computers; and
wherein each of the peers in the network is a servent that acts as both a client and a server to distribute data between the peers in response to a query generated by one of the peers.
